(19) United States
(12) Patent Application Publication
(10) Pub. No.: US 2014/0185934 A1
(43) Pub. Date: Jul. 3, 2014

(54) PROCESS AND SYSTEM FOR AUTHENTICATING OWNERSHIP OF A PHYSICAL BOOK TO A THIRD PARTY VIA A MOBILE APPLICATION

(71) Applicant: LIGHTLIBRARY, INC., Boston, MA (US)

(72) Inventor: Paul LUKEHART, Boston, MA (US)

(73) Assignee: LIGHTLIBRARY, INC., Boston, MA (US)

(21) Appl. No.: 13/793,706

(22) Filed: Mar. 11, 2013

Related U.S. Application Data
(60) Provisional application No. 61/748,598, filed on Jan. 3, 2013.

(51) Int. Cl. G06K 9/18

(52) U.S. Cl. CPC G06K 9/18
USPC 382/182

(57) ABSTRACT

A user's mobile device has an application that, when employed, verifies and authenticates to a third party that the user has ownership of a physical book. Use of the application's process allows unique identification of each book by means of ISBN lookup in conjunction with a) signature image analysis or b) a generated unique identifier code, and assigns that book to the user's account. User possession of the book is associated with ownership in the user's account and ownership is authenticated by assigning the unique book to the user's account. Fraud or multiple use prevention is built into the application and process. Evidence of authentication is sent to the interested third party for use in distribution of e-books in a manner contingent on ownership of the physical book.

### CROSS-REFERENCE TO RELATED APPLICATION

This application claims the benefit under 35 U.S.C §119 (e) to U.S. Provisional Application No. 61/748,598 entitled A Process and System for Verifying and Authenticating Ownership of a Physical Book to a Third Party via a Mobile Application, filed on Jan. 3, 2013, the contents of which are incorporated in its entirety by reference herein.

### FIELD

The present disclosure relates to a process and system for verifying and authenticating ownership of a physical book to a third party via a mobile application.

### BACKGROUND

The information age has produced an explosion of content for people to read. This content includes traditional media such as books, magazines, newspapers, newsletters, manuals, guides, references, articles, reports, documents, etc. that exist in print, as well as electronic media in which the aforesaid works are provided in digital form. The Internet has further enabled an even wider publication of content in the form of document downloads, such as portable document files and e-books.

As digital media have proliferated, a number of devices have become available for consumption of the media. These devices include mobile phones such as the iPhone™, tablet computers such as the iPad™, laptop computers, desktop computers, and electronic readers such as the Kindle™. Readership of media propagated on these devices has been growing rapidly over the last decade, particularly in the area of e-book consumption.

As users transition to utilizing these devices, they commonly retain personal libraries of hard-copy books that they still wish to read, but which are inaccessible on e-readers, necessitating repurchase of the titles for consumption in the new format. The majority of users for the majority of titles choose to forego repurchasing books they already own simply to have them accessible in the new format.

### SUMMARY

In one aspect, the present disclosure relates to a method for electronically recording ownership of a physical book. In some embodiments, the method can include electronically receiving an image of a title page of a physical book and an indication of an identity of a user; analyzing the image using optical character recognition to determine the presence of an international standard book number (“ISBN”) for the physical book and a unique identifier; and associating the user with the physical book in a database using the unique identifier. In some embodiments, the unique identifier can be a human signature. In some embodiments, the presence of two unique identifiers in the image can prevent verification of ownership. In some embodiments, violation of an access rule can prevent verification of ownership. In some embodiments, the unique identifier can be an alphanumeric code. In some embodiments, the method can include previously transmitting the alphanumeric code to the user. In some embodiments, the method can include storing the ISBN and the unique identifier in a database. In some embodiments, once the user is associated with the physical book, the method can include transmitting, to a third party, an indication of ownership of the physical book. In some embodiments, the method can include transmitting to a third party a request to transmit an electronic book corresponding to the ISBN. In some embodiments, upon receiving a payment from the user and the electronic book from the third party, the method can include electronically transmitting the electronic book to a device associated with the user. In some embodiments, the method can include verifying ownership by the user of the physical book using the unique identifier.

Another aspect of the present disclosure relates to a system for electronically recording ownership of a physical book. In some embodiments, the system can include a database for storing data related to ownership of a physical book and instructions stored in a computer readable medium for electronically receiving an image of a title page of a physical book and an indication of an identity of a user; analyzing the image using optical character recognition to determine the presence of an international standard book number (“ISBN”) for the physical book and a unique identifier; and associating the user with the physical book in the database using the unique identifier

### BRIEF DESCRIPTION OF THE DRAWINGS

FIG. 1 is a high-level block diagram of a system for verifying or authenticating ownership of a physical book, according to some embodiments of the present disclosure;

FIG. 2 is a block diagram of a system for verifying or authenticating ownership of a physical book, according to some embodiments of the present disclosure;

FIG. 3A is a flow diagram of a process for authenticating ownership of a hard-copy book via a mobile application, according to some embodiments of the present disclosure;

FIG. 3B is a flow diagram of a process for authenticating ownership of a hard-copy book via a mobile application, according to some embodiments of the present disclosure;

FIG. 4A is an example illustration of a page of content with text and a picture;

FIG. 4B is an example illustration of a page of content with text and a picture;

FIG. 5 is an example illustration of a page of content with ISBN and user signature identified, according to some embodiments of the present disclosure;

FIG. 6 is a flow diagram of a process that enables the application to deliver content to the consumer, according to some embodiments of the present disclosure.

### DESCRIPTION

According to some aspects of the present disclosure, user's mobile device has an application that, when employed, associates ownership of a physical book to a user account and authenticates to a third party that the user has ownership of a physical book. Use of the application's process allows unique identification of each book by means of ISBN lookup in conjunction with a user-added unique identifier, such as a) signature image analysis or b) a generated unique identifier code, and assigns that book to the user's account. User possession of the book is thus associated with ownership and ownership is authenticated to third parties by assigning the unique book to the user's account. Fraud or multiple-use prevention is built into the application and process. Evidence of ownership is sent to the interested third party for use in distribution of e-books in a manner contingent on authentication of ownership of the physical book.

Intended use of this authentication process would be integration into a mobile application to enable users to record ownership of their personal print libraries and allow publishers, distributors, and retailers to issue e-book licenses or distribute e-books in a manner consistent with prior ownership of a given title. For example, this manner allows the publishers, distributors, and retailers to come to such agreements necessary to issue the e-books at a price discounted to full retail price to the end user, enabling monetization of existing personal libraries of hard-copy books and increasing convenience to the end user.

Thus, publishers, distributors, and retailers may wish to employ means of verification and authentication of user ownership of books in order to sell an additional license of the title in e-book form to the user at a discounted rate or render other value-added services contingent on ownership of the book in hard copy.

Two exemplary processes are discussed below. However, the present invention is not limited to those exemplary embodiments. Each exemplary embodiment includes the addition of a user-added unique identifier to the print copy of the book and subsequent analysis of the identifier via the mobile platform. These exemplary methods include method A) of the user's application of a signature to the copyright page, and the alternate method B) of a user's application of an application-generated unique identifying number to the book

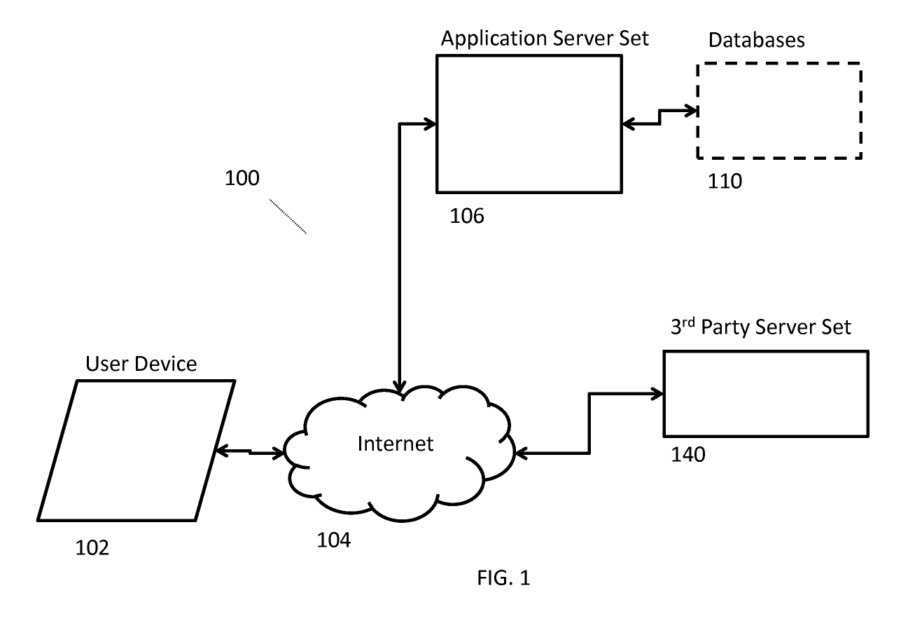

FIG. 1 is a pictorial diagram showing an operating environment 100 for implementing one exemplary embodiment of the present disclosure. The operating environment 100 shown includes operating environments with search, analysis, and delivery functions which are accessible by user devices over the internet and includes user device 102, internet 104, application server set 106, databases 110 and third party server set 140.

User Device 102, which may be any mobile device such as a smartphone or tablet computer that users can use to access the application process, communicates with the application servers 106 via one or more computer networks such as the Internet 104. Protocols and components for communicating via the internet are well-known to those of ordinary skill in the art of computer network communications. Communication between user devices 102 and the servers 106 and 140 may also be enabled by local wired or wireless computer network or cellular data connections.

The application system 100 depicted in FIG. 1 can operate in a distributed computing environment including several computer systems that are interconnected via communication links, e.g., using one or more computer networks or direct connections. However, it will be appreciated by those of ordinary skill in the art that the system 100 can equally operate in a computer system having fewer or greater number of components than are illustrated in FIG. 1. Thus, the depiction of the operating environment 100 in FIG. 1 should be taken as exemplary, and not limiting to the scope of the present disclosure.

Application server set 106 can include the software, databases, and associated communications routines and protocols essential to their interoperability and communications. Server set 106 is generally responsible for providing front-end user communications with various user devices, such as devices 102, hosting and running software packages that deliver the process functionality, and back-end communications with third party servers 140. Application server set 106 also maintains application databases 110, which store all datasets required for application functionality. Third-party server set 140 can be responsible for delivering lookup and operational functionality which is not contained in application server set 106. This may include such functionality as search or interface with other vendor systems. In some embodiments, user device 102, databases 110, application servers 106 and third party servers 140 are located remotely from each other. However, in some embodiments, one or more of user device 102, databases 110, application servers 106 and third party servers 140 can be co-located.

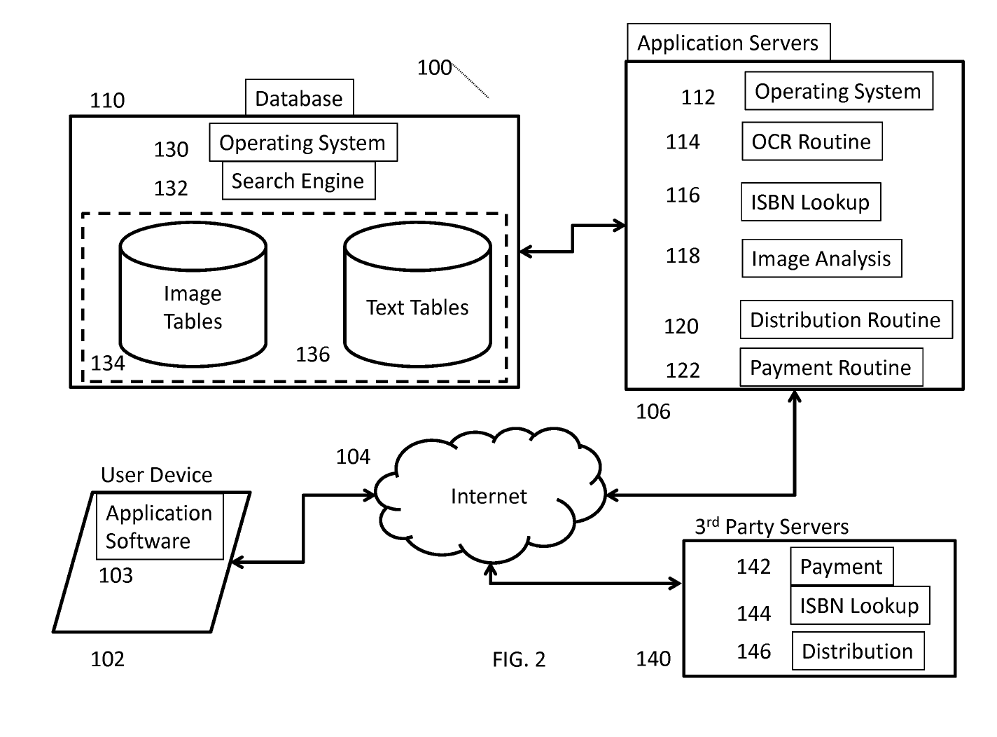

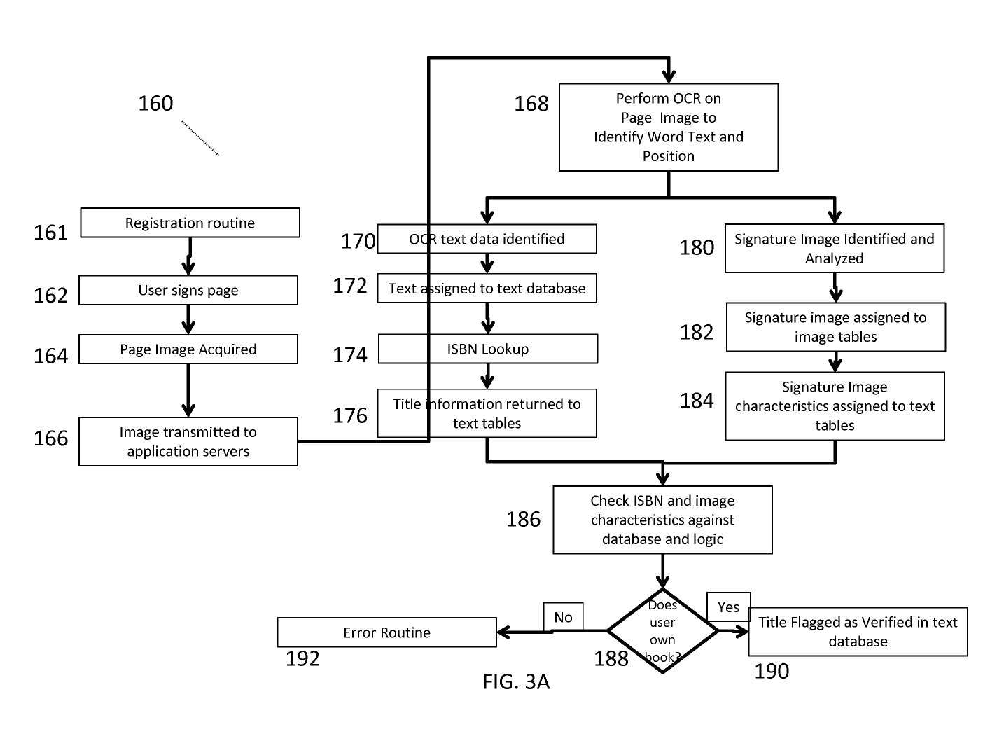

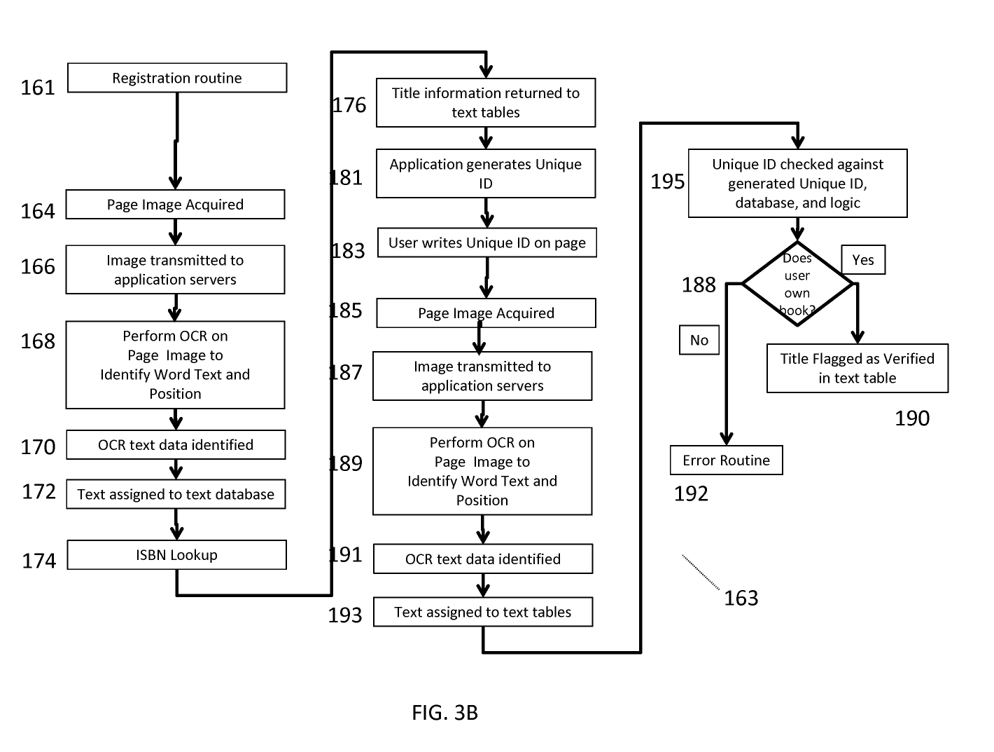

FIG. 2 illustrates exemplary computing components that are responsible for the operation of the operating environment 100 shown in FIG. 1 and for the execution of the embodiment of the process in FIGS. 3A and 3B. The user device 102, for example, typically has many different software modules running on it to make it functional. Modules may be part of the built-in functionality of the device, or they may be added to the device by the user. Such added modules (or “applications”) are available from third-party vendors, and add to the functionality of the device either by using its native functionality or adding functionality by accessing remote servers via the internet 104 previously. User device 102 can include application software 103. Databases 110 can include an operating system 103, a search engine 132, image tables 134 and text tables 136. Application servers 106 can include an operating system 112, an Optical Character Recognition (OCR) routine module 114, an ISBN lookup module 116, an image analysis module 118, a distribution routine 120, and a payment routine 122. Third party servers 140 can include a payment module 142, an ISBN lookup module 144, and a distribution module 146.

In some embodiments, user device 102 can have application software 103 installed that uses (1) the data transmission capability of the device and (2) the image capture functionality of the user device 102, which creates a digital image file following usage of the device's internal camera system. Such functionality is common to mobile devices. For example, the transmission capability can include transmission of data over wireless (include cellular and Wi-Fi networks) and wired networks. Image capture functionality can include a camera on the user device, e.g., an image sensor and accompanying software and hardware for capturing images using the image sensor.

In some embodiments, application software 103 can serve as the interface by which the user interacts with the application server set 106. However, other embodiments may include additional functionality, such as in a case where a OCR routine and an Image Analysis functionality are integrated into the application software 103.

User device 102 communicates with application server set 106 via Internet 104 using known data transfer protocols. A digital image captured by the user device 102 can be transferred via these protocols from user device 103 to application server set 106 and stored in image tables 118 for analysis by OCR routine 114 and image-analysis software 116.

Application server set 106 in some embodiments of the computing environment contains multiple modules. Those of ordinary skill in the art will appreciate that these modules represent functionality that can be depicted in multiple ways, so long as they are interoperable and the net functionality is maintained. Thus the set of systems depicted in FIG. 2 should be taken as exemplary and not limiting. Generally speaking, the application server set 106 includes an operating system 112 that provides executable program instructions for the general administration and operation of the servers. This operating system also coordinates the other routines and modules running on the application server set 106. These routines and modules may communicate with each other and also with databases 110 in order to store or retrieve data, as well as with third-party servers 140 via the internet 104.

Included in the application server set 106 can be software capable of conducting Optical Character Recognition, indicated by OCR Routine module 114. OCR routine 114 will be addressed in more detail in connection with FIG. 3A. Additional programs or routines also are included in the application server set. ISBN lookup routine/module 116 is a query routine that accesses third-party server set 140 to retrieve title data for analysis and storage. Image Analysis module 118 is representative of a software suite capable of analyzing image files for particular distinct graphical characteristics and will be further described in FIG. 3A. Distribution routine 120 can be a software suite or routine capable of facilitating data transfer between the databases 110 and third party servers via the internet 104. Data transfer in this case refers to querying one set of servers in order to provide relevant information to the other, so distribution routine 120 both queries and sends information. For example, in one embodiment of the process, distribution routine 120 may be configured to recognize that certain fields or flags have been associated with a customer account. In this case, “fields” or “flags” each refer to particular data fields in the database which are populated with logical values for subsequent reference about whether a function or routine has been performed, and with what outcome. In this case, the fields and flags are dependent on the outcome of OCR routine 114 and ISBN lookup routine 116. In the present embodiment, these fields may be populated with “True” or “False” (or logical equivalents) by OCR routine 114 and ISBN lookup routine 116 if other conditions relating to the authentication of the book ownership are met. A customer's account may be flagged to indicate association of a particular title with a user account, indicating ownership—in other words, to return “True” when queried by distribution routine 120—if all conditions in the authentication process are met. Other fields may be populated with data indicating that some of the conditions have been met. All of these fields can be used for later reference by distribution routine 120 in order to convey to a third party the exact status of association of a given title query to the customer's account.

Distribution routine 120 can then send query results referencing flags in the customer account indicating the routine outcomes to third party servers 140; the third party servers 140 may send confirming data to distribution routine 120, which can then route the data to databases 110. The payment routine 122 also interacts with third-party servers in order to complete payment transactions with all involved parties. For example, payment routine 122 may be configured to recognize that certain fields or flags have been associated with customer accounts, and to subsequently process a payment with a payment vendor.

Database 110 stores information related to the ownership of particular books and can include image tables 134 and text tables 136. Database operating system 130 manages and communicates with both image tables 134 and text tables 136. Database 110 also is configured to receive search instructions from search engine 132 and return results from the image tables 134 and/or database 136. Text tables 136 in this embodiment is exemplary of one method of recording data from multiple sources, and the same result may be achieved by having multiple databases or data tables within the same database. Text tables 136 is intended to record data transmitted by the user from user device 102 via the internet 104 and application servers 106, which may include identifying information of the user and title, as well as information for payment processing, data extracted from other routines, or other data types or fields as may be useful for analysis, records, or transaction purposes. Those of ordinary skill in the art will recognize that the databases typically employ a memory and main processor in which program instructions are stored and executed for operation of the servers. Application servers 106 include executable program instructions for maintaining and updating the databases 134 and 136 and responding to instructions received from the application server routines.

Text tables 136 may be organized as desired. In one embodiment, content may be associated with images in the image tables. The digital page images captured by user device 102 and sent in a positive image file format such as JPEG or PNG are stored in the image tables 134 while text corresponding to the page images is stored in text tables 136. In association with each page image, text tables 136 preferably includes information that identifies the position and size of the text (and possibly non-text objects associated with the extracted text) as found on the respective page image. All of this information may be compressed in the text tables to reduce the storage space required. Text tables 136 and image tables 134 can be configured such that the data fields within the tables can be referenced through indexing elements such as primary keys or other identifiers, which enables queries of the database based on those indexing elements to return multiple data types as may be needed individually or associated with other data types. Text tables 136 may include data tables populated by outputs of the various routines described herein, customer account information, or other information as deemed necessary to the functioning of the process. Image tables 134 may include data tables populated by raw or processed image data, including image files from user devices 102 or outputs of the various routines described herein such as OCR routine module 114.

Third-party servers 140 include sources of externally-based data and services that the present embodiment requires to complete the authentication process and any subsequent transactions. The referenced “third parties” are any independent entities that maintain or operate the externally based data or services. Payment module 142 for example may include all interfaces with parties to payment processes contingent on a customer purchase. These parties may include credit card company interfaces, online payment interfaces, bank interfaces, or other methods of remitting payment remotely. These interfaces are commonly used in digital commerce. ISBN lookup module 144 includes the externally query-accessible databases containing information necessary to determine a book title's edition from its ISBN, and further whether the title is available as an eBook. Examples of such query-accessible databases can include online booksellers engaged in selling eBooks. The particular database to be queried can be determined by customer account information specifying which database is most applicable to the customer's eBook reading device. For instance, the customer may have an eBook account with Vendor A, and this information would be logged in the customer account information in text tables 136. Thus, ISBN Lookup routine 116 would reference the customer account information, access Vendor A's ISBN lookup server 144, and return the title information and availability. Distribution servers 146 include a series of server interfaces which may vary by transaction, depending on which service is used. Due to the nature of eBook distribution channels, the servers may belong to publishers, retailers, or other parties in the distribution network. The common functionality of these servers is that they have integrated systems for sending eBooks or rendering other services to users. In this case, the integrated systems are configured to receive outside information and distribute the product or service accordingly. Additionally, the third-party servers 140 are generally capable of interacting with each other through the internet 104, which functionality may be utilized in some of the routines described herein.

FIG. 3A represents an embodiment of a process 160 by which a particular print title may be recorded to and associated with a customer's account, thus implying user's ownership of a hard-copy book which may then be authenticated to a third party. Ownership in this case refers to having a book in the physical possession of the user, and authentication refers to the process by which a unique set of characteristics of the book are associated with the user account in order to identify the book as unique and in possession of the user, and such authentication may then be relayed to third-parties itself or by a proxy message indicating that authentication criteria have been met. Those with ordinary skill of the art will appreciate that the exact sequencing of steps represented here may not be the only or best way of accomplishing the end result of ownership authentication, so this embodiment should be taken as exemplary and not as an exhaustive means of execution. The exemplary method includes the steps of: user establishes application account (registration routine) 161; user signs page 162; page image acquired 164; image transmitted to application servers 166; perform OCR on page to image to identify word text and position 168; then the text is processed as follows (1) OCR data identified 170; text assigned to text tables 172; ISBN lookup 174; title information returned to text tables 176; and the signature is processed as follows (2) signature image identified and analyzed 180; signature image assigned to image tables 182; signature image characteristics assigned to text tables 184; then check ISBN and image characteristics against database 186; check to see if user owns book 188, if yes, ISBN flagged as verified in text tables 190; if no perform error routine 192.

In block 161, the user completes a registration routine to establish an application account. Establishing an account is a process common to any application software package that offers services to an individual user dependent on personal information. In establishing an account, the user will input such information as will enable the application to associate a particular print book, identified with the user-added unique identifier, with his account. This information can include information identifying and enabling access to other user accounts, such as those associated with the user's third-party e-reader account, or the user's name, address, contact information, payment information, social media information, or other information pertinent to identifying and providing services to the customer. Thus this is common to applications, but in this case performs the function of providing information that can be indexed in databases 110 with data provided in subsequent steps in order to enable recording of title information and association with the user account in order to provide the authentication service.

The user signs the copyright page of his book in block 162. The signature placement will be directed by the application instructions so that the user performs this task correctly, and may be instructed to place the signature in particular area of the page. The signature itself is a handwritten mark commonly used to authenticate agreement or presence on physical documents. It is recognized by those with ordinary skill in the art as a user-added unique identifier, unique to each individual yet having variability from mark to mark. Thus, it in this case serves to uniquely identify the copyright page, but cannot be perfectly replicated as in the case of a stamp.

Block 164 indicates the user acquiring the page image with user device 102. This is the step by which the image of the signed page is captured and the image file generated by user device 102. This image is captured by the application through use of an image sensor on mobile device such as tablet computer or smartphone, although it could also be completed with a camera networked or integrated to a laptop or other computing device. Following the image capture, application software 103 on the user device 102 can cause user device 102 to transmit the image file to application servers 106 via Internet 104 and the methods described above. In this embodiment, the image file is not retained on user device 102, although in some embodiments the retention of the image may be advantageous for purposes of executing subsequent analysis on the image. Following transmission, the image file is processed by application servers 106. Those with ordinary skill in the art will appreciate that some of the following functionality may be maintained in application software 103, but for purposes of this embodiment will be depicted as occurring at application servers 106. In block 168, the application servers module OCR routine 114 performs OCR on the page image.

For each page image of content, a recognition routine such as Optical Character Recognition (OCR) may be performed on the page image as necessary to identify the text, position, and size of each word on the page, as indicated in optical character recognition (OCR), may be performed on the page image as necessary to identify the text, position, and size of each word on the page. It should also be understood that a “word” encompasses any grouping of one or more characters, numbers, or symbols. Moreover, a word may stand alone or be associated with a non-text object, such as a picture or graphic. OCR routines are well known in the art of electronic document processing and do not require further discussion herein. The OCR analysis produces several outputs, among them text data and image data. While in this embodiment, the captured image is transmitted to application servers 106 for processing, in some embodiments, application software 103 on the user device 102 can perform the OCR analysis. Accordingly, in this embodiment, user device 102 transmits the output of the OCR analysis to application server 106 for further processing and storage.

Block 170 indicates that the text data from the page image has been analyzed and identified. This data includes the text read by the OCR routine, and as indicated in block 168 the location of each of the pieces of text as well. In one implementation, the position and size information is recorded as “quads,” which include four numbers representing the X and Y position and the width and height of the text or images as they appear on a particular page image.

Block 172 is a representation of the software protocols assigning this text to the Text tables 136. From this point, block 174 indicates the process of the software protocols in the application servers conducting a search of the third-party servers 140 based on the text information extracted in step 170. The goal of this search is to identify the book by its International Standard Book Number or ISBN. The ISBN is a publishing industry standard 10- or 13-digit number commonly assigned to books when published in order to uniquely identify the title and edition of the work. Those of ordinary skill in the art will recognize that only the ISBN associated with the particular title can be on a book's copyright page, and then that the particular book is further uniquely identified by the addition of the handwritten signature. Thus, searching for the ISBN is a method of returning title-specific information on the book from which the data was extracted in block 168. Following the ISBN Lookup 174 routine, the resulting title information is stored in Text Tables 136 as indicated in block 176.

Those with ordinary skill in the art will appreciate that databases can be configured so that data fields across data tables or even whole databases correspond through the use of primary keys or other indexing methods utilizing unique identifiers such as customer identification numbers. In the case of this process, such methods are employed in the database software protocols to ensure that the datasets extracted from the page image are associated with the page image records through the use of the unique identifier or primary key. Further, the page images themselves are indexed or associated with the user account.

As the OCR is performed in block 168, the human signature also can be identified by the OCR software as an image, and image-processing software creates an image of the signature in block 180. Block 180 is also representative of additional analysis that may be performed on the signature image, such as assigning coordinates to the image or running additional digital image processing routines on the image, which may result in information that enables computer recognition or comparison of the image at a later time.

After the image is analyzed, it is assigned to Image Tables 134 in block 182. The signature image is indexed in such a manner that it corresponds to the page image and corresponding data extraction.

Block 184 represents the subsequent step of storing the output of the analysis shown in block 180. The output of the analysis in block 180 may be expressed in string or text format or in image format. The portion of this output associated with the signature image that is in text or string format also is indexed to correspond to the subject page image. The image characteristics discerned from analysis routines that can be reduced to text also are stored in a likewise manner. The image file itself may be stored in the image tables for further reference or analysis as is required for authentication purposes.

In block 186 the software protocols in the application servers 106 check the data extracted in block 168 against existing records in database 110. This is to ensure that the page image with the signature has a unique set of characteristics, which can be derived from data extracted from the position of the text and image on the page, the makeup of the images, or other techniques. If the search for identical characteristic sets returns no matches, then the image is unique.

The logic indicated in block 186 is a set of instructions governing authentication, such that the page meets a set of criteria necessary to ensuring that the book has been signed only once and in a valid manner. Multiple signatures or no signatures would not provide evidence of individual ownership, but a single signature renders the copy of the book unique to the user. This embodiment of the process depicts a single signature being used as authentication criteria; however, image analysis, security, and lookup protocols may be utilized in such a way as to enable recognition of the book page as having new signatures, and thus having changed ownership. In one embodiment of the process, the software logic for determining authentication would include determining whether multiple human signatures were present in the page image, or whether the signature present was consistent with the user's previous signatures, and qualifying or disqualifying the image as valid based upon the analysis. Additional logic may be included based on access rules such as disqualifying certain geographic locations which may have a high fraud likelihood. In any event, the access rules may be written in programming code that a computer can interpret and execute to implement the access rules. Systems for writing and executing such code are known in the art of computer programming.

Decision block 188 indicates the results of the check performed in block 186. If the image characteristics meet all uniqueness criteria, then the user is determined to have a unique book, the book information is associated with the user account, and ownership is authenticated. If this is the case and the user does own the book, block 190 indicates the process step of the authentication server software routine putting a flag on the title in the user's account to indicate book ownership. Conversely, if the image is determined by the logic to not meet the criteria for ownership, the application software 103 will conduct an error routine and not flag the book as verified. This error routine may result in actions such as notifying the user to attempt the process again, a disqualifying flag being put on the title in the user's account, or other actions deemed necessary. However, the output of the process is not to flag the title as verified.

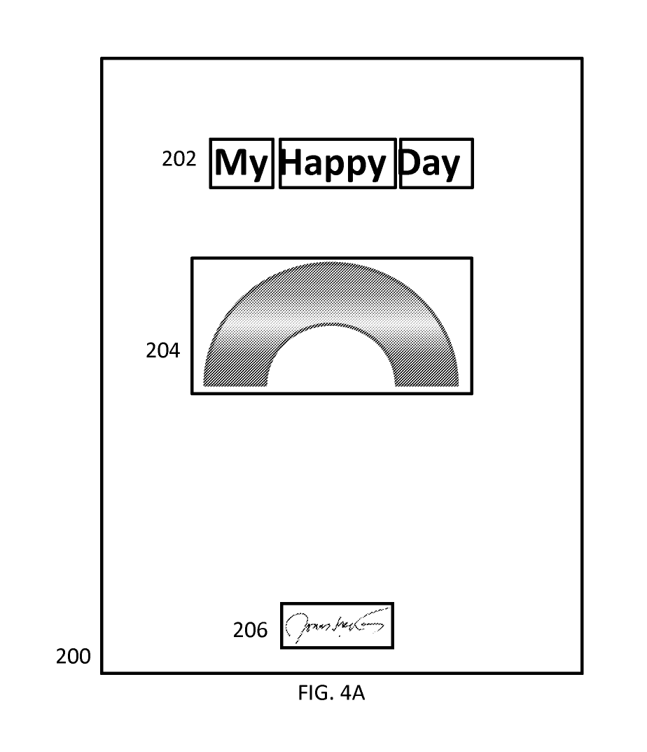

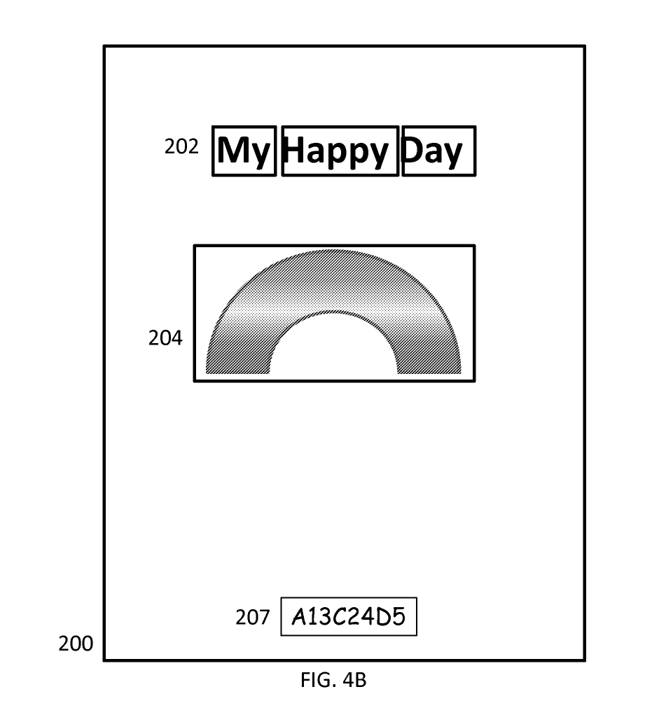

FIG. 4A is exemplary of a book page image with text and signature identified by an OCR routine, similar to the output expected from block 168 in FIG. 3A. Exemplary book page image can include text 202, image 204 and a signature 206. Block 200 is representative of the whole page. Block 202 indicates that the text has been recognized and separated into words. Block 204 is representative of an image that may be recognized as such by the OCR routine. Block 206 is representative of a human signature, which may then be recognized and analyzed as explained in previous figures.

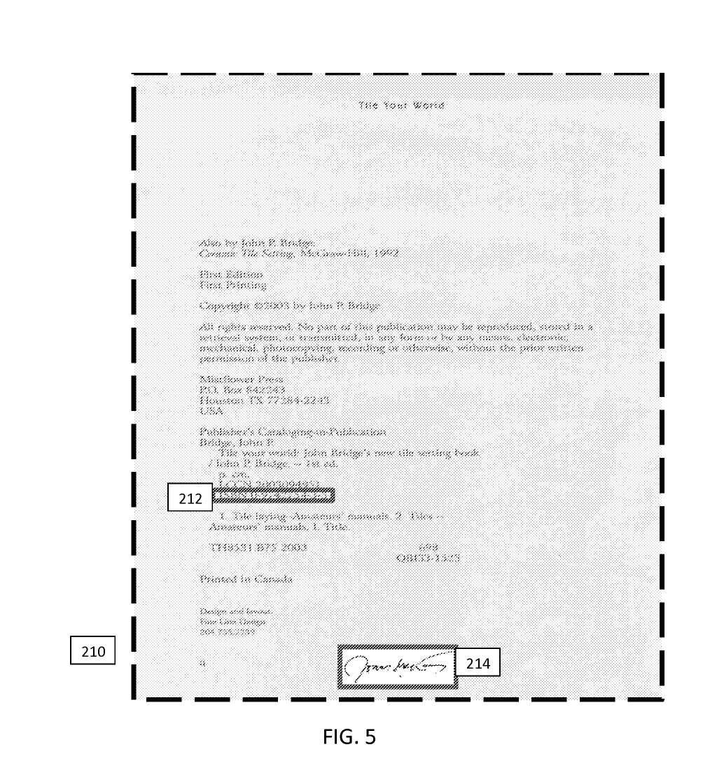

FIG. 5 is an exemplary image capture of a book page 210 with ISBN 212 and signature 214 highlighted, according to some embodiments of the present disclosure. Block 210 indicates the page-image capture by the user device 102. Block 212 demonstrates the location of the ISBN, which itself would be read for the ISBN lookup routine as discussed previously, and would be located on paper as described earlier by the use of “quads.” Block 214 represents a human signature on the page, which would be recognized, located, and analyzed as described in FIG. 3A. It should be noted that the relative location of the signature image quads and the ISBN quads will differ from user to user, and thus will provide a unique set of identifying data for each signed page.

FIG. 3B represents an additional embodiment of a process by which a user's ownership of a hard-copy book may be authenticated. Ownership in this case refers to having a book in the physical possession of the user, and authentication refers to the process by which a unique set of characteristics of the book are associated with the user in order to identify the book as unique and in possession of the user. Those with ordinary skill of the art will appreciate that the exact sequencing of steps represented here may not be the only or best way of accomplishing the end result of ownership authentication, so this embodiment should be taken as exemplary and not an exhaustive means of execution. The exemplary method includes the steps of: user establishes application account 161; page image acquired 164; image transmitted to application servers 166; perform OCR on page to image to identify word text and position 168; then the text is processed as follows: OCR data identified 170; text assigned to text tables 172; ISBN lookup 174; title information returned to text tables 176; application generates Unique Identification number (ID) 181; user writes Unique ID on page 183; page image acquired 185; image transmitted to application servers 187; perform OCR on page image to identify word text and position 189; OCR text data identified 191; text assigned to text tables 193; Unique ID identified 195; Unique ID checked against application-generated Unique ID, database, and logic 197; then check ISBN and image characteristics against database 186; check to see if user owns book 188, if yes, ISBN flagged as verified in text tables 190; if no, perform error routine 192.

In block 161, the user is required to complete a registration routine to establish an application account as described in the previous process embodiment description. Thus this is common to applications, but in this case performs the function of providing information that can be indexed in databases 110 with data provided in subsequent steps in order to provide the authentication service.

Block 164 indicates the user acquiring the page image with user device 102. This is the step by which the image of the page is captured and the image file generated by user device 102. This image is captured by the application through use of an image sensor on a mobile device such as tablet computer or smartphone, although it could also be completed with a camera networked or integrated to a laptop or other computing device. Following the image capture, application software 103 on the user device 102 can cause user device 102 to transmit the image file to application servers 106 via Internet 104 and the methods described above. In this embodiment, the image file is not retained on user device 102, although in some embodiments the retention of the image may be advantageous for purposes of executing subsequent analysis on the image. Following transmission, the image file is processed by application servers 106. Those with ordinary skill in the art will appreciate that some of the following functionality may be maintained in application software 103, but for purposes of this embodiment will be depicted as occurring at application servers 106. In block 168, the application servers module OCR routine 114 performs OCR on the page image.

For each page image of content, a recognition routine such as Optical Character Recognition (OCR) may be performed on the page image as necessary to identify the text, position, and size of each word on the page. as previously discussed. While in this embodiment, the captured image is transmitted to application servers 106 for processing, in some embodiments, application software 103 on the user device 102 can perform the OCR analysis. Accordingly, in this embodiment, user device 102 transmits the output of the OCR analysis to application server 106 for further processing and storage.

Block 170 indicates that the text data from the page image has been analyzed and identified. This data includes the text read by the OCR routine, and as indicated in block 168 the location of each of the pieces of text as well as previously described.

Block 172 is a representation of the software protocols assigning this text to Text Tables 136. From this point, block 174 indicates the process of the software protocols in the application servers conducting a search of the third-party servers 140 based on the text information extracted in step 170. The goal of this search is to identify the book by its International Standard Book Number or ISBN as discussed previously. Thus, searching for the ISBN is a method of returning title-specific information on the book from which the data was extracted in block 168. Following ISBN Lookup routine 174, the resulting title information is stored in the Text Tables as indicated in block 176.

Block 181 indicates the process which results in the application generating a unique identification number (ID). This number is the output of an algorithm designed to generate unique codes on demand. The codes may have letters or number or be alphanumeric in nature and may be generated randomly or according to a set of rules or logic based on other factors, such as the title, location, or other material facts. The code is then placed in a text table and associated with the title data resulting from ISBN Lookup 174 through the use of a primary key or other customer identification number. Once the code has been generated and associated with the title data, it is then displayed to the customer on user device 102.

Block 183 indicates the step in which the user, prompted by instructions on user device 102, observes the unique identification (ID) number generated in block 181 and writes the unique ID in the book on the copyright page. The unique ID can be an alphanumeric, numeric, symbolic code, or any other type of code that is unique to the user and to the ISBN of the particular book. This writing is ideally able to be read by computer reading protocols such as the OCR routine described previously. The placement of the unique ID on the page also has the effect of uniquely marking the book with a code that can be read and referenced for future indexing purposes.

Block 185 is representative of the same page image acquisition step conducted in block 164, except that it is the second such acquisition in this process flow.

Block 187 is representative of the same image transmission step as represented in block 166.

Block 189 is representative of the same OCR protocol routine as conducted in block 168. In this case, however, the routine ideally also identifies the user-written unique ID number generated in the process in block 181 and written in block 183. An example of the placement and style of the unique ID number may be observed in FIG. 4B, block 207. Those with ordinary skill in the art will recognize that OCR routines are capable of identifying and parsing hand-written text as well as printed text.

Block 193 is representative of the same process as occurred in block 170. Ideally, the OCR routine is configured such that it identifies the format of the unique ID and places the unique ID in a unique ID field in the text tables for the title.

Block 195 represents the lookup routine by which the application software checks the unique ID identified during OCR routine 191 against the unique ID generated in block 181 and other logic governing access rules as discussed previously.

Decision block 188 indicates the results of the check performed in block 195. If the image characteristics meet all uniqueness criteria, then the user is determined to have a unique book and ownership is authenticated. If this is the case and the user does own the book, block 190 indicates the process step of the authentication server software routine putting a flag as previously explained on the title in the user's account to indicate book ownership. Conversely, if the image is determined by the logic to not meet the criteria for ownership, the application software 103 will conduct error routine 192 and not flag the book as verified. Error routine 192 may result in actions such as notifying the user to attempt the process again, a disqualifying flag being put on the title in the user's account, or other actions deemed necessary. However, the output of the process is not to flag the title as verified.

FIG. 4B is exemplary of a book page image with text and unique id identified by an OCR routine. Exemplary book page image can include text 202, image 204 and a unique id 207. Block 200 is representative of the whole page. Block 202 indicates that the text has been recognized and separated into words. Block 204 is representative of an image that may be recognized as such by the OCR routine. Block 206 is representative of a unique id, which may then be recognized and analyzed as explained in previous figures.

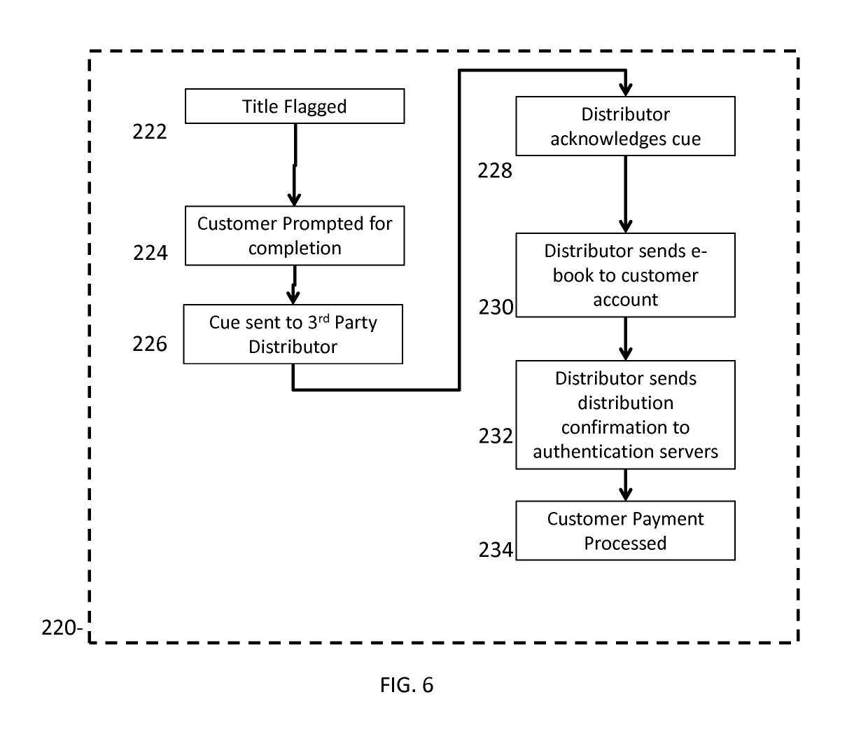

FIG. 6 is an embodiment of a process 220 by which the authentication is conveyed to third parties for transaction purposes, the transaction is receipted, and the third party distributes the e-book or service to the customer. In some embodiments, the steps of the process can include title flagged 222; customer prompted for transaction completion 224; cue sent to third party distributor 226; distributor acknowledges cue 228; distributor sends e-book to customer account 230; distributor sends distribution confirmation to authentication servers 232; customer payment processed 234. Block 222 indicates the successful indication of the authentication process 160 and the association of a flag indicating authentication with the title in the customer's account. Block 224 corresponds to the step of prompting the customer to complete the transaction. On affirmative response to the prompt, authentication servers 106 conduct distribution routine 120, which begins at block 226. Block 226 indicates the step of the routine by which an electronic cue is sent to the appropriate third-party distributor for the title. This cue is an electronic signal or message transmitted via the internet 104 and includes information pertinent to distribution, for example, customer account details, title information, and evidence or vouching of authentication. Distributors are the parties with legal authority to distribute the book in e-copy format. The third-party distributor acknowledges the cue in block 228 by means of a receipt returned to the distribution servers 106. In block 230, the distributor then sends the authenticated e-book to the customer account indicated in the cue in block 226. Subsequently in block 232, the distributor sends a confirmation back to the authentication servers 106 as a means of confirming that the distribution event has taken place. The final step 234 is payment processing by the authentication servers 106. Payment processing software and routines are well-known in internet-related commerce.

Intended use of this association and authentication process would be integration into a mobile application to enable users to verify ownership of their personal libraries, and would allow publishers, distributors, and retailers to issue e-book licenses or distribute e-books to users in a manner consistent with prior ownership of a given title. For example, this manner can allow the publishers, distributors, and retailers to come to such agreements necessary to issue the e-books at a price discounted to full retail price to the end user, enabling monetization of existing personal libraries of hard-copy books and increasing convenience to the end-user.

Embodiments of the disclosed subject matter can be implemented in computer hardware, firmware, and/or computer programs executing on programmable computers or servers that each includes a processor and a storage medium readable by the processor (including volatile and non-volatile memory and/or storage elements). Any computer program can be implemented in a high-level procedural or object-oriented programming language to communicate within and outside of computer-based systems. Any computer program can be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the embodiments. The embodiments, or portions thereof, can also be implemented as a machine-readable storage medium, configured with a computer program, where, upon execution, instructions in the computer program cause a machine to operate to perform the functions of the embodiments described above.

Embodiments of the disclosed subject matter can be used in a variety of applications. Although the embodiments, or portions thereof, are not limited in this respect, the embodiments, or portions thereof, can be implemented with memory devices in microcontrollers, general purpose microprocessors, digital signal processors (DSPs), reduced instruction-set computing (RISC), and complex instruction-set computing (CISC), among other electronic components. Moreover, the embodiments, or portions thereof, described above can also be implemented using integrated circuit blocks referred to as main memory, cache memory, or other types of memory that store electronic instructions to be executed by a microprocessor or store data that may be used in arithmetic operations.

The descriptions herein are applicable in any computing or processing environment. The embodiments, or portions thereof, may be implemented in hardware, software, or a combination of the two. For example, the embodiments, or portions thereof, may be implemented using circuitry, such as one or more of programmable logic (e.g., an ASIC), logic gates, a processor, and a memory. While several particular forms of the disclosed subject matter have been described, it will be apparent that various modifications are possible. It is not intended that the disclosed subject matter be limited to the particular embodiments described here. Other advantages and novel features of the disclosed subject matter may become apparent from the detailed description when considered in conjunction with the drawings.

The above-presented description, including screen shots, pseudo-code, variables, elements and/or algorithmic steps, figures, images and illustrations is intended by way of example only and is not intended to limit the disclosed subject matter in any way. It is particularly noted that the persons skilled in the art can readily combine the various technical aspects of the various exemplary embodiments described as well as their constituent elements and sub-systems to implement features and processes contemplated to be within the scope of the disclosed subject matter but not literally or explicitly described.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

A “server,” “client,” “agent,” “module,” “interface,” and “host” is not software per se and includes at least some tangible, non-transitory hardware that is configured to execute computer readable instructions.

What is claimed is:

1. A method for electronically recording ownership of a physical book, the method comprising:
electronically receiving an image of a title page of a physical book and an indication of an identity of a user;
analyzing the image using optical character recognition to determine the presence of an international standard book number (“ISBN”) for the physical book and a unique identifier; and
associating the user with the physical book in a database using the unique identifier.

2. The method of claim 1, wherein the unique identifier comprises a human signature.

3. The method of claim 1, wherein the presence of two unique identifiers in the image prevents verification of ownership.

4. The method of claim 1, wherein violation of an access rule prevents verification of ownership.

5. The method of claim 1, wherein the unique identifier comprises an alphanumeric code.

6. The method of claim 5, comprising previously transmitting the alphanumeric code to the user.

7. The method of claim 1,comprising storing the ISBN and the unique identifier in a database.

8. The method of claim 1, comprising, once the user is associated with the physical book, transmitting, to a third party, an indication of ownership of the physical book.

9. The method of claim 8 comprising transmitting to a third party a request to transmit an electronic book corresponding to the ISBN.

10. The method of claim 9 comprising, upon receiving a payment from the user and the electronic book from the third party, electronically transmitting the electronic book to a device associated with the user.

11. The method of claim 1, comprising verifying ownership by the user of the physical book using the unique identifier.

12. A system for electronically recording ownership of a physical book, the system comprising:
a database for storing data related to ownership of a physical book; and
instructions stored in a computer readable medium for electronically receiving an image of a title page of a physical book and an indication of an identity of a user;
analyzing the image using optical character recognition to determine the presence of an international standard book number (“ISBN”) for the physical book and a unique identifier; and
associating the user with the physical book in the database using the unique identifier.

13. The system of claim 12, wherein the unique identifier comprises a human signature.

14. The system of claim 12, wherein the presence of two unique identifiers in the image prevents verification of ownership.

15. The system of claim 12, wherein violation of an access rule prevents verification of ownership.

16. The system of claim 12, wherein the unique identifier comprises an alphanumeric code.

17. The system of claim 16, wherein the instructions comprise previously transmitting the alphanumeric code to the user.

18. The system of claim 12,wherein the instructions comprise storing the ISBN and the unique identifier in the database.

19. The system of claim 12, wherein the instructions comprise, once the user is associated with the physical book, transmitting to a third party an indication of ownership of the physical book.

20. The system of claim 19, wherein the instructions comprise transmitting to a third party a request to transmit an electronic book corresponding to the ISBN.

21. The system of claim 20, wherein the instructions comprise upon receiving a payment from the user and the electronic book from the third party, electronically transmitting the electronic book to a device associated with the user.

22. The system of claim 12, wherein the instructions comprise verifying ownership by the user of the physical book using the unique identifier.
